(19) United States
(12) Patent Application Publication
(10) Pub. No.: US 2020/0250560 A1
(43) Pub. Date: Aug. 6, 2020

(54) DETERMINING PATTERN SIMILARITIES USING A MULTI-LEVEL MACHINE LEARNING SYSTEM

(71) Applicant: ACT, Inc., Iowa City, IA (US)

(72) Inventor: Zhongmin Cui, Iowa City, IA (US)

(21) Appl. No.: 16/780,516

(22) Filed: Feb. 3, 2020

Related U.S. Application Data
(60) Provisional application No. 62/801,430, filed on Feb. 5, 2019.

(51) Int. Cl. G06N 5/04; G06N 20/00

(52) U.S. Cl. CPC G06N 5/047; G06N 20/00

(57) ABSTRACT

Methods and multi-level machine learning systems for determining pattern similarities are provided. Once pattern similarities are determined, they may be removed or altered from a corresponding data string as described herein.

### CROSS REFERENCE TO RELATED APPLICATIONS

The present application claims priority to U.S. patent application Ser. No. 62/801,430 filed Feb. 5, 2019 and titled “ON A METHOD FOR REMOVING NOISES IN SIMILARITY ANALYSIS,” which is incorporated herein by reference in its entirety for all purposes.

### TECHNICAL FIELD

The disclosed technology relates generally to determining pattern similarities using a multi-level machine learning system and method.

### BACKGROUND

Input responses are provided by users in response to an examination file. These input responses comprise, for example, a set of responses to multiple choice questions in a multiple choice examination file. The set of responses are sometimes checked for indicators that the user has cheated in some way. However, these standard indicators are inaccurately inflated when identifying an incidence of cheating. Better systems and methods are needed.

### BRIEF SUMMARY OF THE EMBODIMENTS

Embodiments of the disclosure provide systems and methods for determining and removing or altering pattern similarities in data strings provided by a plurality of user devices. In some embodiments, a multi-level machine learning computer system for determining pattern similarities in data strings provided by a plurality of user devices comprises a processor and a non-transitory computer readable medium with computer executable instructions embedded thereon. The computer executable instructions may be configured to cause the processor to: receive a plurality of input response content from the plurality of user devices, wherein the plurality of input response content is generated by the plurality of users devices in response to an examination file; determine a first data string from the plurality of input response content, wherein the first data string corresponds with a first user device of the plurality of user devices, and wherein the first data string corresponds with responses to the examination file provided by the first user device; determine a substring of the first data string from the first user device, wherein the substring corresponds with the plurality of input response content, wherein the first data string is provided to a first trained machine-learning (ML) model to determine the substring of the first data string, and wherein the first trained ML model identifies a repeating pattern in the first data string that exceeds a repeating threshold value; determine a plurality of substrings corresponding with the plurality of input response content by providing the plurality of input response content to the first trained ML model, wherein the plurality of substrings include the substring of the first data string from the first user device; determine a classification category for a second data string in the plurality of substrings, wherein the classification category is selected from a plurality of classification categories, and wherein determining the classification category and associated confidence score comprises applying a set of inputs associated with the plurality of substrings corresponding with the plurality of input response content to a second trained ML model; and upon determining that the classification category for the second data string is a particular classification category and the associated confidence score for the second data string exceeds a similarity threshold value, transmit an identifier corresponding with the second data string to a second user device.

In some embodiments, the second data string in the plurality of substrings is determined by providing the second data string to the first trained ML model. In some embodiments, the first data string and the second data string are analyzed concurrently by the first trained ML model. In some embodiments, the first trained ML model identifies a repeating pattern of a configurable number of characters or digits. In some embodiments, the plurality of classification categories corresponds with a likelihood of cheating by the plurality of users devices in response to the examination file. In some embodiments, the processor is further configured to: train the second trained ML model using responses to a second examination file provided by a second plurality of user devices.

A computer-implemented method is disclosed for determining pattern similarities in data strings provided by a plurality of user devices, based on the computer system described above.

A computer program product is disclosed for determining pattern similarities in data strings provided by a plurality of user devices, based on the computer system described above.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIG. 1 illustrates a diagram of a multi-level machine learning computer system for determining pattern similarities in data strings provided by a plurality of user devices, in accordance with an embodiment disclosed herein.

FIG. 2 illustrates an example of pattern similarities in data strings, in accordance with an embodiment disclosed herein.

FIG. 3 illustrates sample distributions of Cz index, in accordance with an embodiment disclosed herein.

FIG. 4 illustrates a plurality of input response content, in accordance with an embodiment disclosed herein.

FIG. 5 illustrates examples of first and second data strings corresponding with a particular classification category, in accordance with an embodiment disclosed herein.

FIG. 6 is an illustrative process for determining pattern similarities in data strings, in accordance with an embodiment disclosed herein.

The figures are not intended to be exhaustive or to limit the invention to the precise form disclosed. It should be understood that the invention can be practiced with modification and alteration, and that the disclosed technology be limited only by the claims and the equivalents thereof.

### DETAILED DESCRIPTION OF THE EMBODIMENTS

A typical way for a student user to cheat is to copy responses from another student user with a higher ability that is sitting next to him/her. Some systems for determining whether the student user has cheated involve statistical indices to detect the similarity between the two response vectors. However, these systems utilize unaltered input content that is provided from a student user. As such, the analysis of whether the student user has cheated rarely considers data quality or preparing the data for a similarity analysis. The result of the similarity analysis may be misleading if noise is not removed from the data.

Sources of noise in data include responses from unmotivated student users or student users that run out of time in responding to questions provided with an examination file. Low motivation can happen, for example, when student users have no interest in an examination but must take the examination because of mandatory requirements. These student users may respond to one or more examination questions by repeating a pattern (e.g., “123412341234” or “1111111111”). Another source of noise is a response from a student user who ran out of time. Some of these student users may choose random responses, while others may repeat a pattern of rapid guessing behaviors, which tend to increase toward the end of the examination. Some of these student users may choose random responses, while others may repeat a pattern, including long strings of item responses using the same response option or the same combination of response options.

If two student users happen to use the same pattern, the system may identify an unusually high response similarity between the input response content provided by the two student users. The similarity index value for the pair can be large, which may result in those student users being falsely identified as cheating. For example, the two student users may provide two data strings “abcadbacddabccdbaacdCCCCCCCCCCCCCCCCCCCC” and “dbacddabccdbaacdabcaCCCCCCCCCCCCCCCCCCCC,” respectively, where each character in the data string corresponds with a response provided by the student user in response to a question in a multiple choice examination. In this case, the longest identical string, shown in uppercase, has a length of 20 characters out of the 40 responses provided. Although the index value for the pair is most likely larger than a typical cutoff value, the similarity may be due to their use of the same repeating pattern rather than one student user copying from another.

If quite a few of these pairs are included in an empirical null distribution used to determine the cutoff value for collusion flagging, this cutoff value could be inflated or otherwise larger than what it should have been. As a result, some student users with unusual response similarities may go undetected. Thus, to accurately identify response similarities that may be due to a student user who is uninterested or a student user who has run out of time, better methods are needed to remove noise from data before conducting any similarity analysis (e.g., to identify potential cheating).

Various methods may be implemented to remove noise from this type of data. For example, the system may compute a person-fit statistic. In a person-fit statistic, it is expected that unmotivated student users would produce item-score patterns that are inconsistent with item difficulties. However, identification of a student user can arise for reasons other than motivation, including simply providing incorrect responses. As a result, removing data based on a person-fit index may lead to removal of good data.

In another example, when a calculation of a response time to an examination question is available, careless responding or rapid guessing can be detected by examining the response time spent on each item. For example, a response-time threshold may be determined for flagging rapid-guessed items and the response time may be compared with the response-time threshold. When response time is identified, the response time can be used to examine examination-taking behaviors, including an average amount of time to respond to all items or particular time to respond to harder or easier questions. Response time, however, is not always available. For example, time spent on each item typically cannot be collected for examinations administered on paper, devices that do not use testing software, or devices that are unconnected to a distributed network.

In another example, data noise can be determined by finding repeating patterns in the responses, which can be applied to examinations administered either on a computer or on paper. One might argue that repeating patterns do not necessarily mean careless responding or rapid guessing. For example, the correct responses may happen to be the same for consecutive items. This situation, however, should rarely happen if an examination is constructed by following appropriate examination guidelines. For example, examination guidelines may include that an examination developer should vary location of an answer key, should alter response choices from the middle options which are favored by student users, or should avoid patterns since they can be identified and used inappropriately by student users. Since student users may perceive a pattern when the same responses occurred as few as three times, a serious student user is unlikely to produce responses with a repeating pattern.

Various methods may be implemented to identify repeating patterns from this type of data. For example, the system may compute the length of the longest string repeating the same response option. In some examples, this method may be limited to scenarios where the repeating pattern contains more than one response option (e.g., “ABABABAB”), which might exist in practice. In another example, a suffix tree may be implemented to contain all the suffixes of a given text in a tree structure. Because substrings with the same suffixes can share the same path in a suffix tree, repeating patterns can be found by examining the path from root to leaves. Constructing a suffix tree, however, may be time-consuming and/or computer memory-consuming, or otherwise resource intensive.

In another example, a correlative matrix and/or a string-join operation may be implemented. The correlative matrix may be constructed through pair comparison of all possible pairs of characters in a string; an “n×n” matrix may be required for a string with length “n.” The string-join operation may find the longest repeating pattern by iteratively joining short repeating patterns. In some cases, the generation of repeating patterns may be inefficient because the computational cost of checking is high. Also, scanning the sequence of a string once, which does not require storage of a matrix, may require a preassembled list of all possible patterns. It may be computationally difficult to list all possible patterns because the number of combinations goes up exponentially as the number of characters in a string increases (e.g., corresponding with examination questions or examination response options, etc.).

In these traditional examples, the number of occurrences or the length of a repeated string may not differentiate the following two scenarios: (1) “ABdcbacABbcdaAB” and (2) dcbadbcdaABABAB. In both scenarios, the repeated string “AB” occurs three times. However, only the second scenario is typically provided by student users in careless responding or rapid guessing. The second scenario may also cause problems in a similarity analysis, which can erroneously identify the student user as a potential cheater, whereas the student user may have been uninterested or simply ran out of time to consider and respond to each question.

In an embodiment of the application, a multi-level machine learning computer system is described for determining and removing/altering pattern similarities in data strings. For example, the multi-level machine learning computer system incorporates a data cleaning method based on finding and/or removing or altering repeating patterns prior to initiating an action in association with identifying the cheating student users. The redundancy of characters in a data string of input response content can be identified by comparing the latter part of the string with the former part. Once the repeating patterns are identified and removed (or altered), the multi-level machine learning computer system can initiate a process to determine whether cheating occurred and then initiate an action in association with the cheating student user.

In a sample illustration, the multi-level machine learning computer system can receive input response content (e.g., including a plurality of data strings each corresponding with a student user). The input response content may be generated by a plurality of student user devices when responding to an examination file. In some examples, each of the student user devices may provide responses to common questions included with the examination file. At a first level, the multi-level machine learning computer system can, for example, clean the data using a first machine learning model. This process may remove or alter the repeating patterns in the data that correspond with unmotivated student users or student users that run out of time in responding to questions provided with the examination file. At a second level, the multi-level machine learning computer system can, for example, compare responses from two student users to identify similarities of correct and incorrect responses and/or determine a value corresponding with the likelihood of cheating between these student users. The response content may be transmitted and stored as data strings at the multi-level machine learning computer system for data cleaning and analysis performed by the computer system.

In addition to a similarity analysis, the data analysis process described herein can also help to prepare data for many other analyses. For example, the process can be used to identify unmotivated student users for school intervention and for teacher follow-up as a secondary action. For another example, psychometricians may remove the repeating patterns from data before estimating item parameters under an item response theory model.

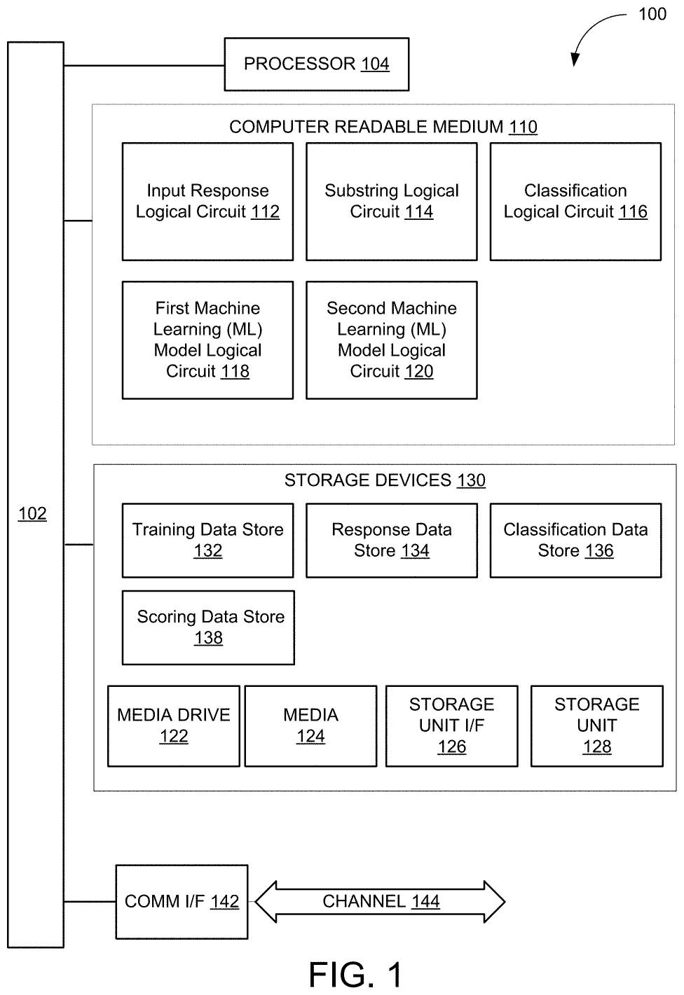

FIG. 1 illustrates a diagram of a multi-level machine learning computer system for determining pattern similarities in data strings provided by a plurality of user devices, in accordance with an embodiment disclosed herein. Computer system 100 may represent, for example, computing or processing capabilities found within desktop, laptop, and notebook computers; hand-held computing devices (PDA's, smart phones, cell phones, palmtops, etc.); mainframes, supercomputers, workstations, or servers; or any other type of special-purpose or general-purpose computing devices as may be desirable or appropriate for a given application or environment. Computer system 100 might also represent computing capabilities embedded within or otherwise available to a given device. For example, a logical circuit might be found in other electronic devices such as, for example, digital cameras, navigation systems, cellular telephones, portable computing devices, modems, routers, WAPs, terminals and other electronic devices that might include some form of processing capability.

Computer system 100 might include, for example, one or more processors, controllers, control engines, or other processing devices, such as processor 104. Processor 104 might be implemented using a general-purpose or special-purpose processing engine such as, for example, a microprocessor, controller, or other control logic. In the illustrated example, processor 104 is connected to bus 102, although any communication medium can be used to facilitate interaction with other components of computer system 100 or to communicate externally.

Computer system 100 might also include one or more memory engines, simply referred to herein as computer readable medium 110. For example, random-access memory (RAM) or other dynamic memory, might be used for storing information and instructions to be executed by processor 104. Computer readable medium 110 might also be used for storing temporary variables or other intermediate information during execution of instructions to be executed by processor 104. Computer system 100 might likewise include a read only memory (“ROM”) or other static storage device coupled to bus 102 for storing static information and computer-readable instructions for processor 104.

Computer readable medium 110 may comprise one or more logical circuits to perform the functions described throughout the disclosure. The logical circuits may include input response logical circuit 112, substring logical circuit 114, classification logical circuit 116, first machine learning model logical circuit 118, and second machine learning model logical circuit 120.

Input response logical circuit 112 is configured to receive one or more input responses corresponding with a plurality of user devices. The input response content may be generated by a student user device and transmitted via a network directly to computer system 100 in response to an examination file. In some examples, the input response content may be received by the student user device at an intermediate device (e.g., a proctor device, etc.) or other application programming interface (API) to transmit to computer system 100.

As a sample illustration, the examination file may comprise a plurality of questions that correspond with multiple choice responses, where the responses are provided by a student user and saved as a data string of input response content. The examination file may include, for example, a 40-item examination and the input response content may comprise 40 responses corresponding with four options: “1,” “2,” “3,” and “4,” or “A,” “B,” “C,” and “D” for simplicity. The input response content may be transmitted from the student user device to computer system 100 (e.g., input response logical circuit 112, etc.).

Input response logical circuit 112 is also configured to receive a data string with a repeating pattern. The repeating pattern may comprise a single response option being repeated or multiple response options being repeated. Some sample repeating patterns may include, for example, “111111111111,” “222222222222,” “333333333333,” “444444444444,” “131313131313,” “124124124124,” or “123412341234.”

Substring logical circuit 114 is configured to determine a repeating pattern. The repeating pattern can be identified by comparing the latter part of the string with the early part.

In an illustrative example, substring logical circuit 114 can construct substrings which start from any character in string “s” and end with the last character of string “s.” For example, s=“1234” and four illustrative substrings can include “1234”, “234”, “34”, and “4,” each starting with “1”, “2”, “3”, or “4” (the four characters in “s”) and ending with “4” (the last character of “s”). For each substring, substring logical circuit 114 can compare it with the other substrings and find the longest identical prefix. For example, substring logical circuit 114 can compare “34” with “1234”, “234”, and “4”, one at a time or concurrently. In this case, the longest identical prefix is zero. In some examples, the longest identical string can start at any position, whereas the longest identical prefix can only start from the first position. The longest identical string may be typically found between two strings with the same number of characters whereas the longest identical prefix may be implemented with strings of different lengths. For example, comparing “1252224” and “1232224” yields a longest identical prefix of “12” with length two and a longest identical string of “2224” with length four.

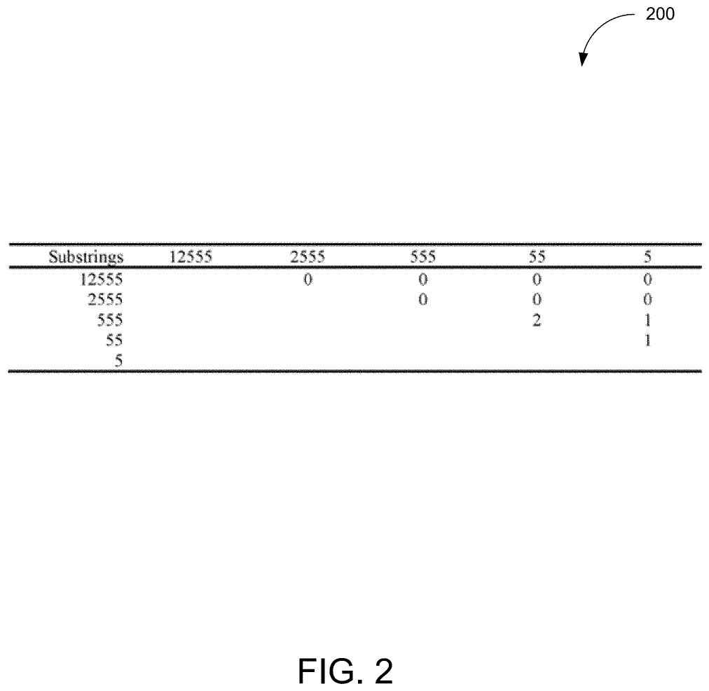

In another example, string “s”=“12555” and substring logical circuit 114 can construct five substrings: “12555”, “2555”, “555”, “55”, and “5”. FIG. 2 shows the pair comparison results in searching for the longest identical prefix. Note that the lower triangle of the table is omitted because of symmetry of the pair comparison. As can be seen from this table, the length of the longest identical prefix was two found in the comparison between “555” and “55”.

Substring logical circuit 114 is also configured to determine an index. In some examples, the length of the longest identical prefix is used to compute the index. The index is defined as the length of the longest identical prefix plus that of the repeated string or character. For example, using “s”=“12555,” the index is two (the length of the longest identical prefix) plus one (the length of the repeating character), which is three. Note that character “5” repeats three times consecutively in the original string.

In some embodiments, the index may correspond with a string of characters. As an illustrative embodiment, for a string with “n” characters, let p1 and p2 denote the starting positions of two substrings subject to constraints of 2≤p1≤n and 1≤p2≤p1−1. Let “I” denote the length of the longest identical prefix between the two substrings; “I”=0 if no identical prefix exists. The index is defined as Cz=max (C*_{z})where:

$${C}_{z}^{*} = \{ \begin{matrix}l + ( {p}_{1} - {p}_{2} ) & l \geq ( {p}_{1} - {p}_{2} ) \\ l & l < ( {p}_{1} - {p}_{2} )\end{matrix} .$$

In some examples, the adjustment of (p1−p2) helps to accurately capture the length of the repeating pattern occurring consecutively. With the example of s=“12555,” I=2 when p1=4 and p2=3, comparing “55” with “555.” The length of the repeating pattern “555,” however, is three rather than two. Adding the adjustment of (p1−p2)=4−3=1 to “I” helps to reconcile this discrepancy.

Substring logical circuit 114 is also configured to determine the substring dynamically, including for example, not constructing and saving substrings in a separate memory block. In some embodiments, substring logical circuit 114 is configured to use an indicator to traverse the data string. For example, the indicator may traverse the first data string (corresponding with a first student user) from a plurality of input response content (corresponding with the group of student users that provided answers in response to the examination).

When substring logical circuit 114 is configured to use an indicator to identify a substring, various embodiments may be used to compute the index. In some examples: 1. Start the indicator at position p1=2. 2. Start the indicator at position p2=1. 3. Compare the substring starting with the character at position p1 (i.e., “2555” for p1=2) and the substring starting with the character at position p2 (i.e., “12555” for p2=1). 4. Compute (i.e., zero for p1=2 and p2 =1). 5. Repeat Steps 2-4 with the next p2 value until p2=p1−1. 6. Repeat Steps 1-5 with the next p1 value until the end of the string is reached. 7. Output the Cz index (i.e., three for s=“12555”).

In another example of computing the index: 1. Start the indicator at position A=2, 2. Compare the substring starting with the character at position A and the substring starting with the character at position Pz and find the identical prefix, where Pz repeats in the range of [1, A−1]. 3. If the prefix exists and the length (I) of the prefix is at least Pz−A, set index C*z=I+(Pz−A); else if the length is less than Pz−A, set index C*z=I. The adjustment on the index value may help account for the repeated character or string as stated in the index definition. 4. Repeat Steps 1-3 with next A value until the end of the string is reached. 5. Output the maximum C*z.

Substring logical circuit 114 is also configured to determine the cutoff value for the index. To identify the repeating pattern of an uninterested student user or the student user has run out of time (e.g., either being associated with a student user who has not cheated), an analyst may compute the Cz index and compare it with a cutoff threshold value. If the index value is larger than the cutoff threshold value, the repeating pattern can be flagged as careless responding or rapid guessing. Past experiences or the distribution of the index value can help the analyst to determine a cutoff threshold value.

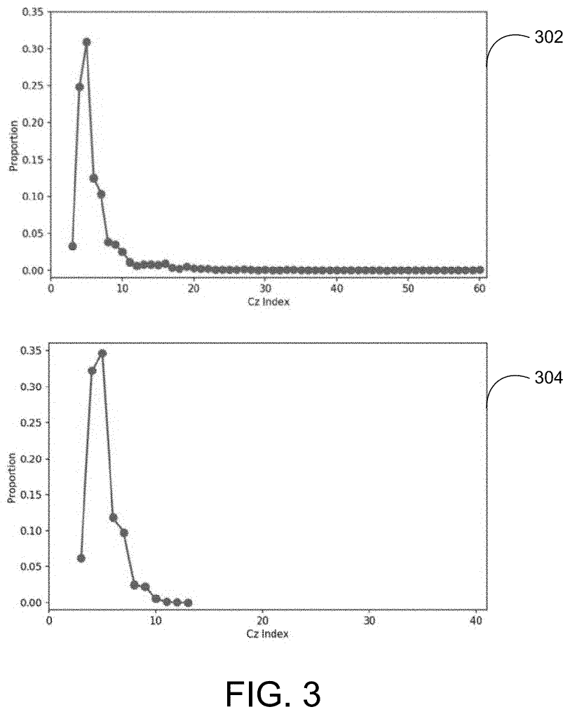

FIG. 3 shows an example distribution of the Cz index computed by substring logical circuit 114. For example, distribution 302 is generated with an elbow around score point 11 which can be used to set the cutoff value. This procedure may be similar to the one used for finding the number of factors through a scree plot. In a second example, distribution 304 shows the distribution of the Cz index around cutoff value of 13 which may, on average, result in zero false positive rate in a data set of 100,000 cases.

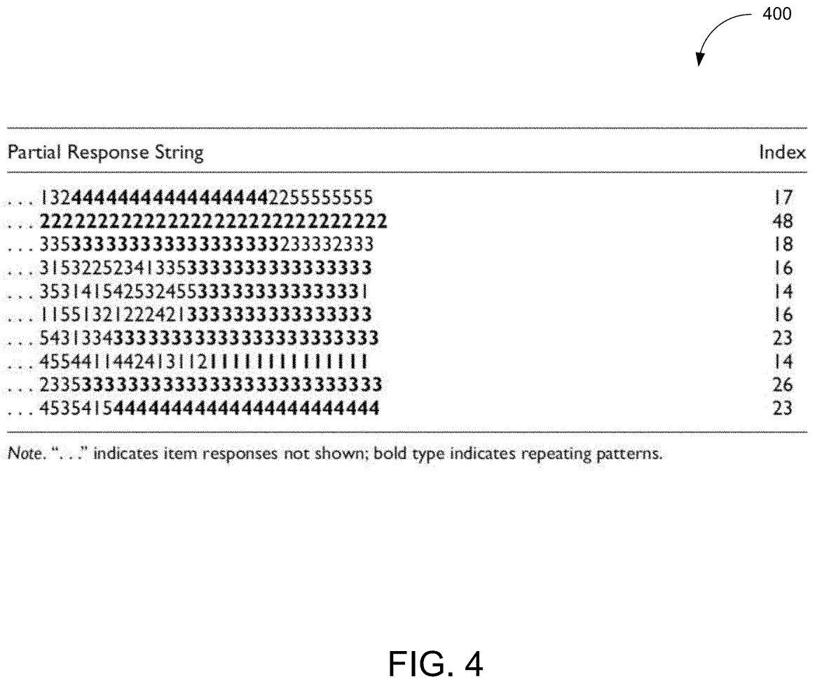

FIG. 4 illustrates a plurality of input response content in association with the determined Cz index by substring logical circuit 114. In illustration 400, all identified cases had a repeating pattern, as highlighted in bold type. The index may be different from the count of the number of a repeating character. For example, the third row in illustration 400 shows that the character “3” occurred 27 times, but only the middle part was identified as possible rapid guessing. The ten student users shown in illustration 400 all had a percentage correct score less than 33.3%. Their Cz index values all fell on the right side of the distribution, shown in distribution 302 of FIG. 3.

Returning to FIG. 1, substring logical circuit 114 is also configured to remove or alter one or more portions of a string, for example, corresponding with the repeating pattern. For example, the flagged repeating pattern can be removed from the string. Alternatively, the entire string can be deleted or altered. Both approaches result in a cleaned dataset without careless responding or rapid guessing. The cleaned dataset is further used by the classification logical circuit 116.

Computer system 100 also comprises classification logical circuit 116. Classification logical circuit 116 is configured to determine a classification category and associated confidence score of a substring of examination responses. For example, classification logical circuit 116 (with second machine learning model logical circuit 120) may manage one or more classification categories of substrings. The classification categories may correspond with student users who cheated or did not cheat, or other classifications, including disinterested or interested, motivated or unmotivated, or whether the student user ran out of time.

Classification logical circuit 116 is also configured to initiate a secondary action with respect to the data string. For example, upon determining that the classification category for the data string is a particular classification category (e.g., motivated, finished the examination, and cheated, etc.) and the associated confidence score exceeds a similarity threshold value (e.g., more than 75% likelihood), classification logical circuit 116 may initiate the secondary action. The secondary action may include, for example, transmitting an identifier associated with the data string to a second user device (e.g., an administrative/teacher user, a parent user, etc.).

First machine learning model logical circuit 118 is configured to determine a repeating pattern that exceeds a repeating threshold value (e.g., more than three times). For example, once the data are received, a first data string (e.g., examination responses from the first student user) is provided to first machine learning model logical circuit 118.

The machine learning technique for identifying the repeating pattern may correspond with the index method described with substring logical circuit 114. For example, first machine learning model logical circuit 118 may, for each substring, compare it with the other substrings and find the longest identical prefix. The length of the longest identical prefix may be used to compute the index and compared with a cutoff threshold value. Other methods may be implemented without diverting from the essence of the disclosure.

In some examples, first machine learning model logical circuit 118 implements one or more machine learning techniques to identify the repeating pattern in the data strings. For example, the machine learning techniques may include a decision tree, linear regression, or other types algorithms that are implemented by first machine learning model logical circuit 118. In some examples, the machine learning algorithm may be trained using a training data set stored with training data store 132. The training data set may be generated by compiling repeating patterns, including repeating patterns identified by substring logical circuit 114. The training data set may also include information created from various end-user input provided through a graphical user interface and/or by scanning paper sources. In some examples, multiple training sets may be generated from the same individual training content source. The machine learning model may then be trained using large quantities (hundreds or thousands) of training data. During the training process, user input may be obtained to adjust model parameters to improve upon the predictive capability and accuracy of models in identifying repeating patterns in input response content.

The repeating pattern may be determined when the repeating characters exceeds a repeating threshold value. The repeating threshold value may be predefined by an administrative user or dynamically defined using training data. For example, the data string may be identified as including a repeating pattern based on sensitivity and/or specificity. Sensitivity may be defined as the proportion of correctly identified response strings with a simulated repeating pattern. Specificity may be defined as the proportion of correctly identified response strings without a simulated repeating pattern.

$$Sensitivity = \frac{{N}_{correctly\_flagged \_as \_repeating \_pattern}}{{N}_{simulated\_repeating \_pattern}} . \\ Specificity = \frac{{N}_{correctly\_flagged \_as \_no \_repeating \_pattern}}{{N}_{no\_repeating \_pattern}} .$$

When the repeating pattern is identified, the computer system may remove the repeating pattern from the first data string. For example, the data string may be altered to remove any characters that correspond with the repeating pattern. As an illustrative example, the repeating “333” from data string “123452342234234333333333333333” may be identified and removed from the data string. First machine learning model logical 118 may be configured to remove the repeating pattern and determine the data string as “123452342234234.”

In some embodiments, first machine learning model logical 118 may be configured to alter the repeating pattern rather than removing it. For example, instead of removing the repeating “333” from data string “123452342234234333333333333333,” first machine learning model logical 118 may be configured to alter the data string to “123452342234234***************” with “*” indicating removed or missing responses. This treatment may be helpful, for example, in estimating item parameters because the kept item responses can still contribute to the parameter estimation of other items. Another treatment is to remove the whole string from further analysis.

Second machine learning model logical circuit 120 is configured to compare the substring with other substrings. The comparison may be executed after removal or alteration of the repeating pattern of each substring by first machine learning model logical 118. The plurality of substrings corresponding with the examination responses that do not include the repeating patterns may be provided to second machine learning model logical circuit 120.

Second machine learning model logical circuit 120 is also configured to determine a classification category for a second data string in the plurality of substrings. The classification category may be selected from a plurality of classification categories (e.g., cheated or did not cheat, disinterested and interested, motivated or unmotivated, or whether the student user ran out of time, etc.). The determination of the classification category and associated confidence score may comprise applying a set of inputs associated with the plurality of substrings (e.g., vector values, weights, etc.) corresponding with the plurality of input response content to a second trained ML model implemented by second machine learning model logical circuit 120.

Machine learning techniques may include a convolutional neural network (CNN), decision tree, linear regression, or other types learning algorithms that are implemented by second machine learning model logical circuit 120. In some examples, the machine learning algorithm may be trained using a training data set stored with training data store 132. The training data set may be generated by identifying past cheating student users, including input response content stored with response data store 134 received by input response logical circuit 112. Response data store 134 and/or training data store 132 may also include information created from end-user input provided through a graphical user interface and/or by scanning paper sources. In some examples, multiple training sets may be generated from the same individual training content source. The machine learning model may then be trained using large quantities (hundreds or thousands) of training data. During the training process, user input may be obtained to adjust model parameters to improve upon the predictive capability and accuracy of models in determining similar responses that may be indicative of cheating in input response content.

Second machine learning model logical circuit 120 may be configured to determine a classification category and associated confidence score associated with each substring of examination responses. When the associated confidence score for a particular substring exceeds a similarity threshold value, the student user may be identified as likely cheating.

Second machine learning model logical circuit 120 may be configured to perform an action. For example, the action may correspond with transmitting the identifier associated with that student user to a panel of user devices to determine secondary actions (e.g., retaking the examination, suspension, etc.). In other examples, the action may correspond with initiating a school intervention and for teacher follow-up.

Computer system 100 might also include one or more various forms of information storage 130, which might include, for example, media drive 122 and a storage unit interface 126. Media drive 122 might include a drive or other mechanism to support fixed or removable storage media. For example, a hard disk drive, a floppy disk drive, a magnetic tape drive, an optical disk drive, a CD or DVD drive (R or RW), or other removable or fixed media drive might be provided. Accordingly, storage media might include, for example, a hard disk, a floppy disk, magnetic tape, cartridge, optical disk, a CD or DVD, or other fixed or removable medium that is read by, written to, or accessed by media drive 122. As these examples illustrate, the storage media can include a computer usable storage medium having stored therein computer software or data.

In alternative embodiments, information storage mechanism might include other similar instrumentalities for allowing computer programs or other instructions or data to be loaded with computer system 100. Such instrumentalities might include, for example, a fixed or removable storage unit 128 and an interface 126. Examples of such storage units and interfaces can include a program cartridge and cartridge interface, a removable memory (for example, a flash memory or other removable memory engine) and memory slot, a PCMCIA slot and card, and other fixed or removable storage units and interfaces that allow software and data to be transferred from the storage unit to logical circuit.

Storage devices 130 may also include training data store 132, response data store 134, classification data store 136, and scoring data store 138.

Training data store 132 may comprise repeating patterns, including repeating patterns identified by substring logical circuit 114. Training data store 132 may also include information created from end-user input provided through a graphical user interface and/or by scanning paper sources. In some examples, multiple training sets may be generated from the same individual training content source.

Response data store 134 may comprise input response content received by input response logical circuit 112 and/or one or more user devices. Response data store 134 may also include information created from end-user input provided through a graphical user interface and/or by scanning paper sources.

Classification data store 136 may comprise one or more potential classification categories that correspond with a data string. The classification categories may correspond with student users who cheated or did not cheat, or other classifications, including disinterested and interested, motivated or unmotivated, or whether the student user ran out of time.

Scoring data store 138 may comprise data corresponding with assigning a confidence value. For example, classification logical circuit 116 may determine the classification category for the data string is a particular classification category (e.g., motivated, finished the examination, and cheated, etc.). second machine learning logical circuit may determine an associated confidence score that the classification category is accurate (e.g., using the data described herein, more than 75% likelihood, etc.).

Computer system 100 might also include a communications interface 142. Communications interface 142 might be used to allow software and data to be transferred between computer system 100 and external devices (e.g., student user devices, etc.). Examples of communications interface 142 might include a modem or soft modem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 142 might typically be carried on signals, which can be electronic, electromagnetic (which includes optical) or other signals capable of being exchanged by a given communications interface 142. These signals might be provided to communications interface 142 via a channel 144. Channel 144 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to media such as, for example, computer readable medium 110, storage 130, and channel 144. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable computer system 100 to perform features or functions of the disclosed technology as discussed herein.

Although FIG. 1 depicts a computer network, it is understood that the disclosure is not limited to operation with a computer network, but rather, the disclosure may be practiced in any suitable electronic device. Accordingly, the computer network depicted in FIG. 1 is for illustrative purposes only and thus is not meant to limit the disclosure in any respect.

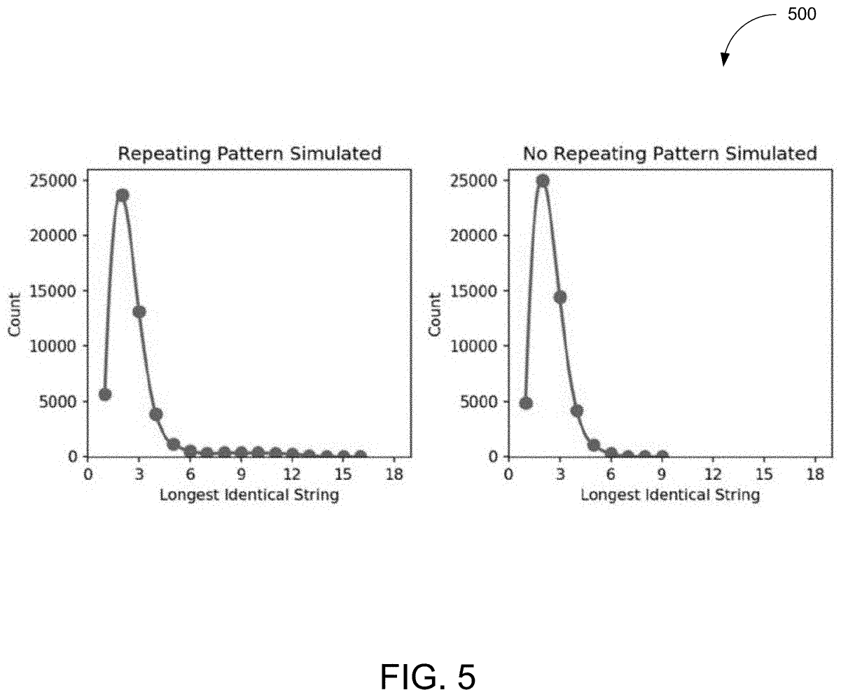

FIG. 5 illustrates examples of first and second data strings corresponding with a particular classification category, in accordance with an embodiment disclosed herein. In illustration 500, a distribution of the length of the longest identical string for both data sets may be provided, including the original data and the cleaned data. With the original data, the similarity index ranged from 1 to 16. In contrast, the range is 1 to 9 for the index computed from cleaned data. As a result, a larger cutoff value would have been chosen if the original data were used to construct the empirical null distribution, as compared with using the cleaned data.

The distribution of the similarity index (i.e., the length of the longest identical string) for both data sets. As can be seen in illustration 500, the distribution of the similarity index for the data with simulated repeating patterns had a longer tail on the right than that for the data without simulated repeating patterns. As a result, a larger cutoff value would have been chosen if the data with repeating patterns were used to construct the empirical null distribution, as compared with using the random data.

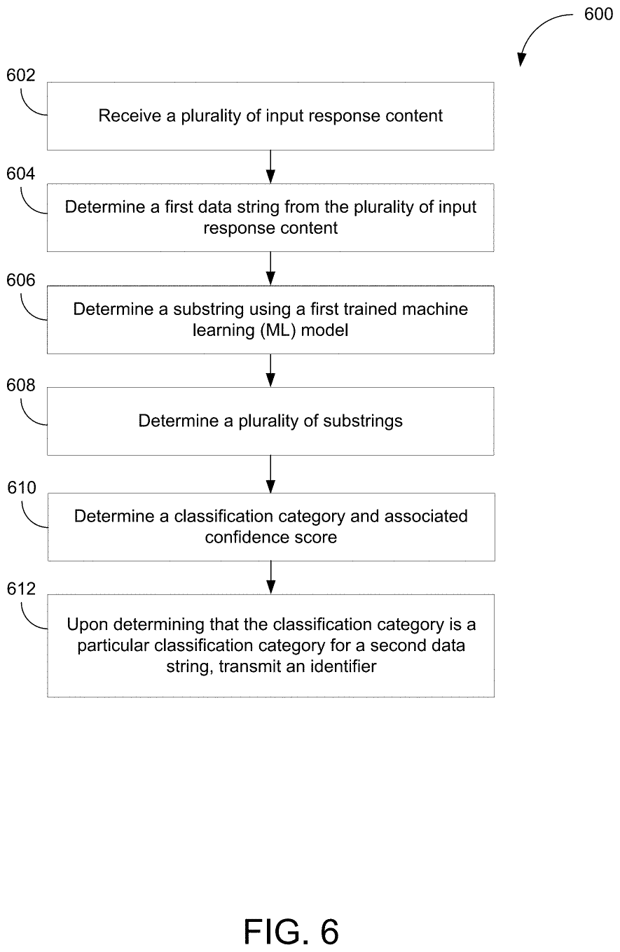

FIG. 6 is an illustrative process for determining pattern similarities in data strings, in accordance with an embodiment disclosed herein. In illustration 600, computer system 100 can execute machine readable instructions configured to cause the processor to perform these and other steps. For example, in addition to or in replacement of the features and components of computer system 100 in FIG. 1, the steps described in FIG. 6 may be performed by a computing component that includes a hardware processor and machine-readable storage medium.

The hardware processor may be one or more central processing units (CPUs), semiconductor-based microprocessors, and/or other hardware devices suitable for retrieval and execution of instructions stored in machine-readable storage medium. The hardware processor may be invoked by computer readable medium 110 to fetch, decode, and execute instructions as steps 602, 604, 606, 608, 610, and 612.

As an alternative or in addition to retrieving and executing instructions, the hardware processor may include one or more electronic circuits that include electronic components for performing the functionality of one or more instructions, such as a field programmable gate array (FPGA), application specific integrated circuit (ASIC), or other electronic circuits.

Machine-readable storage medium may be any electronic, magnetic, optical, or other physical storage device that contains or stores executable instructions. Thus, the machine-readable storage medium may be, for example, Random Access Memory (RAM), non-volatile RAM (NVRAM), an Electrically Erasable Programmable Read-Only Memory (EEPROM), a storage device, an optical disc, and the like. In some embodiments, the machine-readable storage medium may be a non-transitory storage medium, where the term “non-transitory” does not encompass transitory propagating signals. As described in detail below, machine-readable storage medium may be encoded with executable instructions, such as the steps described in FIG. 6.

At step 602, a plurality of input response content may be received. For example, computer system 100 can receive the receive a plurality of input response content from the plurality of user devices. The plurality of user devices may each correspond with student users. The plurality of input response content may be generated by the plurality of users devices in response to an examination file.

At step 604, a first data string may be determined from the plurality of input response content. For example, computer system 100 can determine the first data string. The first data string may correspond with a first user device of the plurality of user devices, including a first student user that operates the first user device in order to generate the first data string. In some examples, the first data string may comprise examination responses provided by the first user device in response to examination questions included with the examination file.

At step 606, a substring may be determined using a first trained machine learning (ML) model. For example, computer system 100 can determine the substring. The substring may correspond with the plurality of input response content. The first data string may be provided to the first trained ML model to determine the substring from the first data string. The first trained ML model may identify a repeating pattern in the first data string that exceeds a repeating threshold value.

In some examples, the first ML model may be configured to remove the repeating pattern from the first data string to generate the substring associated with the first user device. In some examples, the first ML model may be configured to alter the first data string in association with the repeating pattern (e.g., change the repeating pattern “AAA” to “***”, etc.).

At step 608, a plurality of substrings may be determined that correspond with the plurality of input response content. For example, computer system 100 can determine the plurality of substrings corresponding with the plurality of input response content by providing the plurality of input response content to the first trained ML model. The output of the first trained ML model may include the substring without the repeating pattern.

In some examples, a second data string in the plurality of substrings is determined by providing the second data string to the first trained ML model. This may include, for example, receiving input response data from a second user device and providing the second data string from the plurality of input response content to the first trained ML model. The first trained ML model may, for example, remove or alter the repeating pattern from the second data string.

In some examples, the first data string and the second data string in the plurality of input response content may be analyzed by computer system 100 concurrently. For example, first trained ML model may analyze the first data string and the second data string for repeating patterns concurrently. The repeating patterns may be different or similar to each other.

In some examples, the first trained ML model identifies a repeating pattern of characters or digits corresponding with a configurable number. For example, the repeating pattern may identify four characters or digits that are repeated in a first data string. In some examples, the repeating pattern may identify a dynamically determined number of characters or digits.

At step 610, a classification category and associated confidence score may be determined. For example, computer system 100 can determine the classification category for a second data string in a plurality of substrings. The classification category may be selected from a plurality of classification categories. In some examples, computer system 100 may determine the classification category and associated confidence score by applying a set of inputs associated with the plurality of substrings corresponding with the plurality of input response content to a second trained ML model.

In some examples, the plurality of classification categories may correspond with a likelihood of cheating by the plurality of user devices in response to the examination file.

In some examples, the second trained ML model may be trained using responses to a second examination file provided by a second plurality of user devices.

At step 612, upon determining that the classification category is a particular classification category for a second data string, an identifier may be transmitted. For example, computer system 100 can transmit an identifier corresponding with the second data string to a second user device. The identifier may be transmitted upon determining that the classification category for the second data string is a particular classification category and the associated confidence score for the second data string exceeds a similarity threshold value.

Where components, logical circuits, or engines of the technology are implemented in whole or in part using software, in one embodiment, these software elements can be implemented to operate with a computing or logical circuit capable of carrying out the functionality described with respect thereto. One such example logical circuit is shown in FIG. 1. Various embodiments are described in terms of this example computer system 100 comprising one or more logical circuits. After reading this description, it will become apparent to a person skilled in the relevant art how to implement the technology using other logical circuits or architectures.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that can be included in the disclosed technology. The disclosed technology is not restricted to the illustrated example architectures or configurations, but the desired features can be implemented using a variety of alternative architectures and configurations. Indeed, it will be apparent to one of skill in the art how alternative functional, logical, or physical partitioning and configurations can be implemented to implement the desired features of the technology disclosed herein. Also, a multitude of different constituent engine names other than those depicted herein can be applied to the various partitions.

Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “engine” does not imply that the components or functionality described or claimed as part of the engine are all configured in a common package. Indeed, any or all of the various components of an engine, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A multi-level machine learning computer system for determining pattern similarities in data strings provided by a plurality of user devices, the computer system comprising:
a processor and a non-transitory computer readable medium with computer executable instructions embedded thereon, the computer executable instructions configured to cause the processor to:
receive a plurality of input response content from the plurality of user devices, wherein the plurality of input response content is generated by the plurality of users devices in response to an examination file;
determine a first data string from the plurality of input response content, wherein the first data string corresponds with a first user device of the plurality of user devices, and wherein the first data string corresponds with responses to the examination file provided by the first user device;
determine a substring of the first data string from the first user device, wherein the substring corresponds with the plurality of input response content, wherein the first data string is provided to a first trained machine-learning (ML) model to determine the substring of the first data string, and wherein the first trained ML model identifies a repeating pattern in the first data string that exceeds a repeating threshold value;
determine a plurality of substrings corresponding with the plurality of input response content by providing the plurality of input response content to the first trained ML model, wherein the plurality of substrings include the substring of the first data string from the first user device;
determine a classification category for a second data string in the plurality of substrings, wherein the classification category is selected from a plurality of classification categories, and wherein determining the classification category and associated confidence score comprises applying a set of inputs associated with the plurality of substrings corresponding with the plurality of input response content to a second trained ML model; and
upon determining that the classification category for the second data string is a particular classification category and the associated confidence score for the second data string exceeds a similarity threshold value, transmit an identifier corresponding with the second data string to a second user device.

2. The multi-level machine learning computer system of claim 1, wherein the first trained ML model removes the repeating pattern from the first data string to generate the substring associated with the first user device.

3. The multi-level machine learning computer system of claim 1, wherein the first trained ML model alters the repeating pattern from the first data string to generate the substring associated with the first user device.

4. The multi-level machine learning computer system of claim 1, wherein the second data string in the plurality of substrings is determined by providing the second data string to the first trained ML model.

5. The multi-level machine learning computer system of claim 1, wherein the first data string and the second data string are analyzed concurrently by the first trained ML model.

6. The multi-level machine learning computer system of claim 1, wherein the first trained ML model identifies a repeating pattern of a configurable number of characters or digits.

7. The multi-level machine learning computer system of claim 1, wherein the plurality of classification categories corresponds with a likelihood of cheating by the plurality of users devices in response to the examination file.

8. The multi-level machine learning computer system of claim 1, wherein the processor is further configured to:
train the second trained ML model using responses to a second examination file provided by a second plurality of user devices.

9. A computer-implemented method for determining pattern similarities in data strings provided by a plurality of user devices, the method comprising:
receiving, by a computer system, a plurality of input response content from the plurality of user devices, wherein the plurality of input response content is generated by the plurality of users devices in response to an examination file;
determining, by the computer system, a first data string from the plurality of input response content, wherein the first data string corresponds with a first user device of the plurality of user devices, and wherein the first data string corresponds with responses to the examination file provided by the first user device;
determining, by the computer system, a substring of the first data string from the first user device, wherein the substring corresponds with the plurality of input response content, wherein the first data string is provided to a first trained machine-learning (ML) model to determine the substring of the first data string, and wherein the first trained ML model identifies a repeating pattern in the first data string that exceeds a repeating threshold value;
determining, by the computer system, a plurality of substrings corresponding with the plurality of input response content by providing the plurality of input response content to the first trained ML model, wherein the plurality of substrings include the substring of the first data string from the first user device;
determining, by the computer system, a classification category for a second data string in the plurality of substrings, wherein the classification category is selected from a plurality of classification categories, and wherein determining the classification category and associated confidence score comprises applying a set of inputs associated with the plurality of substrings corresponding with the plurality of input response content to a second trained ML model; and
upon determining that the classification category for the second data string is a particular classification category and the associated confidence score for the second data string exceeds a similarity threshold value, transmitting, by the computer system, an identifier corresponding with the second data string to a second user device.

10. The computer-implemented method of claim 9, wherein the first trained ML model removes the repeating pattern from the first data string to generate the substring associated with the first user device.

11. The computer-implemented method of claim 9, wherein the first trained ML model alters the repeating pattern from the first data string to generate the substring associated with the first user device.

12. The computer-implemented method of claim 9, wherein the second data string in the plurality of substrings is determined by providing the second data string to the first trained ML model.

13. The computer-implemented method of claim 9, wherein the first data string and the second data string are analyzed concurrently by the first trained ML model.

14. The computer-implemented method of claim 9, wherein the first trained ML model identifies a repeating pattern of a configurable number of characters or digits.

15. The computer-implemented method of claim 9, wherein the plurality of classification categories corresponds with a likelihood of cheating by the plurality of users devices in response to the examination file.

16. The computer-implemented method of claim 9, further comprising:
training the second trained ML model using responses to a second examination file provided by a second plurality of user devices.

17. A computer program product for determining pattern similarities in data strings provided by a plurality of user devices, the computer program product comprising:
receiving a plurality of input response content from the plurality of user devices, wherein the plurality of input response content is generated by the plurality of users devices in response to an examination file;
determine a first data string from the plurality of input response content, wherein the first data string corresponds with a first user device of the plurality of user devices, and wherein the first data string corresponds with responses to the examination file provided by the first user device;
determine a substring of the first data string from the first user device, wherein the substring corresponds with the plurality of input response content, wherein the first data string is provided to a first trained machine-learning (ML) model to determine the substring of the first data string, and wherein the first trained ML model identifies a repeating pattern in the first data string that exceeds a repeating threshold value;
determine a plurality of substrings corresponding with the plurality of input response content by providing the plurality of input response content to the first trained ML model, wherein the plurality of substrings include the substring of the first data string from the first user device;
determine a classification category for a second data string in the plurality of substrings, wherein the classification category is selected from a plurality of classification categories, and wherein determining the classification category and associated confidence score comprises applying a set of inputs associated with the plurality of substrings corresponding with the plurality of input response content to a second trained ML model; and
upon determining that the classification category for the second data string is a particular classification category and the associated confidence score for the second data string exceeds a similarity threshold value, transmit an identifier corresponding with the second data string to a second user device.

18. The computer program product of claim 17, wherein the first trained ML model removes the repeating pattern from the first data string to generate the substring associated with the first user device.

19. The computer program product of claim 17, wherein the first trained ML model alters the repeating pattern from the first data string to generate the substring associated with the first user device.

20. The computer program product of claim 17, wherein the second data string in the plurality of substrings is determined by providing the second data string to the first trained ML model.
